(19) United States
(12) Patent Application Publication
(10) Pub. No.: US 2006/0265285 A1
(43) Pub. Date: Nov. 23, 2006

(54) System and method for managing sales completion on mobile devices

(76) Inventors: Glenn Hamasaki, Mission Viejo, CA (US); Bindu Rama Rao, Laguna Niguel, CA (US)

Correspondence Address: Bindu Rama Rao, 21 Henley Drive, Laguna Niguel, CA, 92677, US

(21) Appl. No.: 11/130,751

(22) Filed: May 17, 2005

(51) Int. Cl. G06Q 20/00

(52) U.S. Cl. 705/16

(57) ABSTRACT

The present invention categorizes incomplete sales events into categories and analyses them to determine if a standard set of steps of “corrective steps” can be taken to “resolve” these unsuccessful sales attempts. In one embodiment, a sales completion client categorizes incomplete sales events into a set of predefined categories and employs the sales pattern detector for such purposes. In another embodiment, sales management server, in conjunction with a sales completion engine, facilitates the execution of bridge tasks.

### RELATED APPLICATIONS

The present application makes reference to, claims priority to, and claims benefit of U.S. Provisional Patent Application Serial No. ______, entitled “SYSTEM AND METHOD FOR MANAGING SALES COMPLETION ON MOBILE DEVICES” (Attorney Docket No. GH2004US01), filed May 17, 2004, the complete subject matter of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often are used to initiate and purchase mobile content and services. For example, a user may employ his mobile device to purchase and download software. Mobile devices in general are very limited in their support for extensive user interactions. They are very tiny, have keys that are often unusable for real work, and have limited resources. Thus, conducting online purchases using mobile devices are very cumbersome and often end up becoming interrupted or aborted.

For various reasons, after the initiation of a mobile transaction the user may not complete the mobile transaction. Currently, there are no automated mechanisms that can notify the network of the failed attempt or assist a user to complete this interrupted transaction. A user who cannot successfully complete a sales transaction using a mobile device will be reluctant to attempt the same or similar transaction again. This results in lost sales opportunities for the carrier network or a sales entity that is associated with the sales event. Mobile devices, being resource constrained and with small LCD screens are a challenge for service providers and mobile sales is particularly problematic, especially since it is often not clear why a sales attempt was not successfully terminated. Further limitations and disadvantages of conventional and traditional approaches will become apparent to one of skill in the art, through comparison of such systems with some aspects of the present invention as set forth in the remainder of the present application with reference to the drawings.

One of the problems of mobile devices is that of setting schedules of activities to be executed by the mobile device. Each mobile device can set it's own clock, and the local clock of the device is often quite different from a server's clock. Quite often the server has no means to ascertain what the clock of the mobile device has been set to. There is thus no guarantee on when a mobile device will follow a given schedule when the clock on the device can be changed by a user and the clock may be off.

Currently, the growth of wireless applications and services are skyrocketing. Unfortunately, the growth of these applications and services is mirrored by increased complexity of the mobile devices. This complexity is serving as a deterrent for wide spread adoption of next generation applications and services severely reducing the market opportunity.

### BRIEF SUMMARY OF THE INVENTION

A method and/or device supporting firmware update using an update agent in a mobile device, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a perspective diagram of a sales completion network comprising a mobile device communicatively coupled to a carrier network to which an optional third party sales management server may also be communicatively coupled;

FIG. 2 is a perspective block diagram of an embodiment of the present invention wherein USB based removable flash memory storage devices comprise of both a USB male adapter as well as a USB female adapter such that two such units could be plugged into each other for transferring data from one to the other;

FIG. 3 is a perspective block diagram of a sales completion network that comprises a sales completion system spread across a mobile device and a carrier network;

FIG. 4 is a flow chart showing an exemplary operation of the sales completion network of FIG. 1;

FIG. 5 is a flow chart showing an exemplary operation of the sales completion network of FIG. 1 wherein a sales completion client connects to the sales management server to check a master database for known issues for this mobile device and configuration, when the sales completion client fails to resolve the issue accessing a local abbreviated database maintained by the sales completion client; and

FIG. 6 is flowchart of an exemplary operation of the sales completion network as it maintains and employs a data mining repository of sales events and patterns of failures.

### DETAILED DESCRIPTION OF THE INVENTION

Aspects of the present invention relate generally to the process of conducting sales using mobile devices, and more specifically, to the use of a sales completion client or a sales completion engine to facilitate completion of interrupted sales events. The following discussion makes reference to the term “electronic device” that is used herein to refer to mobile electronic devices such as, for example, a mobile handset, a cellular phone, a personal digital assistant (PDA), a pager, and a personal computer, to name just a few. Although the listed example electronic devices are mobile devices, application of the present invention is not limited in this manner, as representative embodiments of the present invention may be employed in a wide variety of electronic devices, both fixed and mobile.

Electronic devices may be adapted to access sales servers to retrieve sales related information and conduct sales related transactions. An electronic device may be, for example, a mobile electronic device having sales software such as mobile cellular phone handsets, personal digital assistants (PDAs), pagers, MP-3 players, digital cameras, etc.

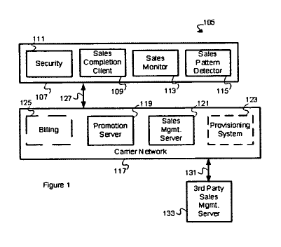

FIG. 1 is a perspective diagram of a sale completion network 105 comprising a mobile device 107 communicatively coupled to a carrier network 117 to which an optional third party sales management server 133 may also be communicatively coupled. The mobile device 107 comprises a sales completion client 109, a sales monitor 113, a sales pattern detector 115 and a security component 111.

The carrier network 117 comprises a sales management server 121, a promotion server 119, an optional provisioning system 123 and an optional billing system 125.

In one embodiment, the sales completion client (SCC) employs a Rules engine that is used to alert operators of end users behavior and tendencies, categorizing end user behavior based on a pattern detected, and automatically triggering an optimal response for each pattern detected.

The sales completion network 105 supports a standard business cycle for making a purchase comprising of four components:

1. Awareness

2. Consideration

3. Trial

4. Purchase

When a sales event is interrupted, many end users progress to stage two or three but do not get to stage four. In one embodiment of the present invention, a sales completion engine (SCE) has been designed to assist an end user in moving from stage two or three to stage four.

In one embodiment, a plurality of categories of unsuccessful sales termination is identified and managed. There are several reasons why a mobile transaction is not completed, and these reasons are identified, categorized and managed. By grouping these reasons logically, for example, it is possible to address instances of each of these categories with an appropriate solution. Each of the categories may have a standard user pattern that may be used to detect the sales problem prior to its occurrence. An example of categories may include:

Portal error

Input fields not responding

Data connection

Pricing

Inability of the user to successfully try the product

The present invention categorizes incomplete sales events into such categories and analyses them to determine if a standard set of steps of “corrective steps” can be taken to “resolve” these unsuccessful sales attempts. In one related embodiment, the sales completion client 109 categorizes incomplete sales events into a set of these predefined categories, employing the sales pattern detector 115 for such purposes. It also employs the sales monitor 113 to determine sales events as they occur so as to gather information on sales related events for analysis. It interacts with the sales management server 121 to initiate management activities that help in sales completion.

In one embodiment, the sales completion network 105 supports the conducting of successful trials that often lead to a successful sale. As it is important to ensure that users who sign up for a trial do conduct the trial and provide feedback, the sales completion network 105 provides for the successful feedback collection. Quite often, there is no follow up with the user after a trial has been initiated, and the sales completion network 105 facilitates such follow up. At the end of the trial period, the user is likely to reject the product if he has not tried its features substantially, and, in order to avoid such a situation, the sales completion engine tracks the usage of the registered user and promotes interaction with a user who might be inadequately exposed to, or inadequately testing, the product under trail.

Incentives to complete a trial and report it are essential for some sales cycles, and the sales completion network supports promoting incentive programs and tracking incentive programs. It incorporates a promotional scheme and an incentive scheme to help induce users into trails and to help them conduct the trails successfully. The promotion server 119 provides information on current sales promotion and provides information on the type or kind of users that must be involved in, or targets of, such sales promotions. To the extent the trial can be tracked, and successful usage can be determined, such information can also be used to complete a sale if a trail does not lead to a sale. In general, the sales management server 121 coordinates sales completion activities with the sales completion client 109.

In one embodiment, a sales management system, comprising the sales completion client 109, the sales monitor 113, the sales pattern detector 115, the sales management server 121 the promotion server 119 and the 3^{rd} party sales management server 133, monitors sales events conducted by the mobile device 107 in the carrier network 117 and facilitates completion of interrupted sales events. In a related embodiment, the sales monitor 113 and the sales pattern detector 115 are located in the carrier network, communicatively coupled to and accessible by the sales management server 121.

In one embodiment, a mobile sales channel is employed by the sales completion client 109 to conduct mobile sales. The mobile sales channel provides sales information to the user, such as those presented and maintained by a 3^{rd} party sales management server 13 or the sales management server 121. It also incorporates promotional information presented and managed by a promotion server 119. It monitors the mobile sales channel for mobile sales performance. Together, the sales completion client 109, the sales monitor 113, the sales pattern detector 115 and the sales management server 121 form a sales management system that collects mobile transaction information and facilitates completion of interrupted sales events. The sales management system offers mobile information and performance notification as a service to 3^{rd} parties, such as the organization managing the 3^{rd} party sales management server 133. Based upon predefined rules created by the 3^{rd} party the sales management server 133, it automatically notifies the 3^{rd} parties of performance issues in the mobile value chain.

In one embodiment, automated logic for the mobile sales management system is maintained and employed selectively by the sales management network 105. Such automated logic aid in the selection of alternate products, employing alternate credit card accounts, using alternate shipping information, etc. Alternate Information used for sales completion would typically be employed when user-specified initial selections are unavailable or not appropriate. For example, a user may have selected an item to purchase from the mobile device, and the user selections may not be currently available from the vendor. The sales completion client 109, or, in general, the sales management system, ensures the use of alternative means that are automatically selected, to complete the mobile sales event. In some cases an alternative download mechanism, account information, billing vendor, etc. may be required to complete a sales transaction initiated by a user of the mobile device 107.

In one embodiment, automated logic employed by the mobile sales management system incorporate the use of a mobile sales proxy. For example, a mobile user identifies a item they would like to purchase. The mobile user uses his mobile device 107 to gather an item profile for items that the mobile user wants to purchase (or is interested in) via a wireless identification tag associated with, or physically incorporated into, the item of interest. The sales completion client 109 in the mobile device gathers the item profile of the item, converts the item profile into a necessary format, and sends to the sales management server 121 for determination of details of the item of interest, such as its price and availability. The sales management server identifies the item and sends information such as price, availability, etc. and also identifies the nearest physical and logical vendors from where the user could purchase the item, etc.

In one embodiment, the sales management system facilitates mobile sales promotion/campaign by retrieving expiry information for the promotions/campaigns and sending an expiration notice to the user of the mobile device, especially if the user had previously conducted an interrupted sales activity but had not agreed to a sales completion activity. For example, a sales promotion from the host (i.e. operator, MVNO, etc.) may be about to expire. The host queries the sales management system for any user who might have had some level of interest in the promotion previously. The host, employing the sales management server 121, notifies each of these mobile users of the upcoming expiration of the promotion managed by the promotion server 119.

The sales completion client architecture is such as to support individual sales completion channels from vendors which will be prioritized differently from the existing service operator. A generic sales completion client is used by the service operator (such as Sprint in Sprint network or Cox in Cox cable network) and individual sales channels are made available too, with support for different mechanism for the download of objects, trial use of the objects, etc. For example, vendor companies such as Ford, etrade, etc. may use their own special sales channels that the sales completion client 109 supports.

In one embodiment, the sales management server 121 sets a schedule for a sales event on the mobile device 107. It simultaneously communicates a sales event schedule and a device clock to ensure that the device clock does not deviate from the network clock or a server clock which the sales management server 121 employs. Thus the clock on the device is set to the value communicated by the sales management server 121 when a schedule is also set.

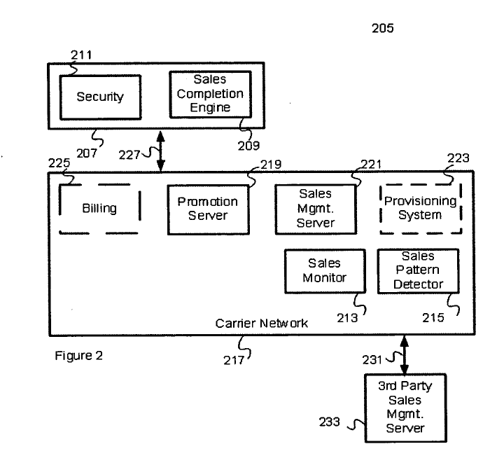

FIG. 2 is a perspective diagram of a sales completion network 205 wherein a mobile device 107 is used to conduct sales with the help of a carrier network 217 that comprises a promotion server 219, a sales management server 221, a sales monitor 213, a sales pattern detector 215, an optional provisioning server 223 and an optional billing system 225. The mobile device 207 comprises a sales completion engine (SCE) 209 and a security component 211.

In one embodiment, the sales completion engine 209 employs a rules engine for wireless networks used to alert operators of end users behavior and tendencies and automatically trigger an optimal response for each pattern of behavior detected.

In one embodiment, the Sales Completion Engine (SCE) 209 is used, in conjunction with sales monitor 213 tracking software in the carrier network 217, to determine the point in the sales cycle where the user has difficulty completing the purchase and subsequently ends the sales cycle. For example, if the end user navigates to the area for downloading applications and services in a multi-step sales process, but each time backs out prior to purchase of the product in the sales cycle, the sales completion client engine 209 and the sales management server 221 will each log this information and automatically generate the optimal “Bridge Task”, or response to assist the user in completing the purchase. The Bridge Task may consist of a SMS message sent to the user offering a free download of the application, an explanation of how the download system works, or a free demonstration of the desired application. The SCE 209 helps conduct the bridge tasks requested by the sales management server 221. It also facilitates the reporting of results of the bridge tasks conducted.

The sales completion network 205 will automatically detect this behavior and after a predefined number (defined by the operator) of attempts the system will automatically generate an SMS message to the user to try a free download, explain how the system works, etc. The message or free play is designed to be the catalyst for adoption of the service that is offered for sale.

In one embodiment, a Java-based rules engine, designed in a modular fashion to interact with remote diagnostic infrastructure of a carrier's network, or a download server, through SOAP interfaces, provides rules processing support that is critical to the determination of corrective steps to be taken, or bridge tasks to be identified, based on the status of incomplete sales events. In a related embodiment, the rules engine is a downloadable rules based engine that can be installed on the mobile device 207. In another embodiment, it is a server-side component that is integrated into the sales management server 221.

Thus, the sales management server 221 in the present invention categorizes incomplete sales events into categories, with the help of the sales monitor 213, and analyzes them, with the help of the sales pattern detector 215 to determine if a standard set of “corrective steps” can be taken to “resolve” these unsuccessful sales attempts. In one embodiment, a sales completion client in the mobile device 207 categorizes incomplete sales events into a set of predefined categories and employs the sales pattern detector 215 for such purposes. In another embodiment, the sales management server 221, in conjunction with a sales completion engine 209, facilitates the execution of bridge tasks.

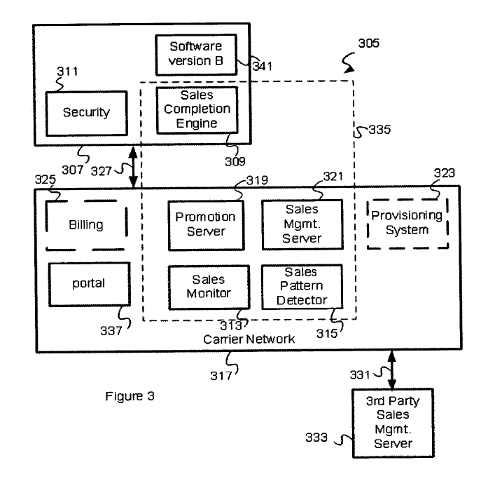

FIG. 3 is a perspective block diagram of a sales completion network 305 that comprises a sales completion system 335 spread across a mobile device 307 and a carrier network 317. Specifically, the sales completion system 335 comprises a sales completion engine 309 in the mobile device 307 that is communicatively coupled to a sales management server 321, in the carrier network 317, a sales monitor 313, a sales pattern detector 315 and a promotion server 319. The sales monitor 313, the sales pattern detector 315 and the promotion server 319 are all communicatively coupled to the sales management server 321.

In one embodiment, the sales completion network 305 is capable of monitoring the mobile sales events conducted over the mobile device 307. Monitoring comprises an identification of any roadblocks to the completion of a mobile sales event. One such road block occurs when the user of mobile device 307 employing a software version B 341 is not able to access a wireless portal C 337 because the URL string for the portal 337 provisioned into the mobile device 307 is too long for a browser or other application employed to conduct the product selection. In response, a sales monitor 313 in the carrier network 317 determines that the user of mobile device 307 and software version B 341 is opting out of the sales transaction process at the same point at which other users have previously opted out or terminated the sales event prematurely. This information is gathered by the sales monitor 313 for processing by various components of the sales completion system 335. The sales completion system 335 gathers information from hundreds of thousands of devices such as the mobile device 307 that comprise a software version B 341.

The sales completion system's 335 is associated with a sales pattern detector 315 that determines that all mobile devices, such as the mobile device 307, with a similar sales event profile encounter the same issue. The sales completion system 335 notifies a corresponding operator/OEM of the issue and a solution is subsequently determined. When the solution is made available for distribution, each mobile device 307 is sent a determined solution/correction and is able to successfully complete the mobile transaction previously initiated.

In one embodiment, the sales management server 321 is combined with the sales monitor 313, the sales pattern detector 315 and the promotion server 319.

In one embodiment, the sales completion system 335 provides a mobile sales channel that can be monitored to facilitate sales completion. Transaction Assistance is provided by a sales completion client that interacts with the sales completion engine 309 in the mobile device 307. In a related embodiment, the sales completion client is resident in the carrier network and interacts with the sales management server 321.

In one embodiment, a sales event activity profile is communicated by the sales management server 321 to the sales completion client 309 at the beginning of the sales event. The sales completion client 309 detects the interruption of the sales event, when it occurs, and uses the sales event activity profile to complete the interrupted sales event.

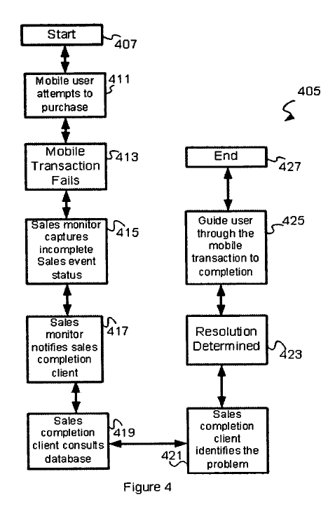

FIG. 4 is a flow chart showing an exemplary operation of the sales completion network of FIG. 1. At a start block 407, the processing starts when a sales event is initiated, typically by a mobile user at a portal. At the next block 411, mobile user attempts to purchase an application from a mobile device 107. Then, at a next block 413, the mobile transaction initiated by the mobile user fails for an unknown reason at some point in the process. Then, at a next block 415, the sales monitor 113 captures the incomplete sales event status.

Then, at a next block 417, the sales monitor 113 notifies sales completion client 109 of incomplete sales event status. Later, at a next block 419, the sales completion client 109 compares captured event information against abbreviated database of known issues with this mobile device 107. Then, at a next block 421, the sales completion client 109 identifies the problem. It locates a resolution, at a next block 423, and guides the user through the mobile transaction to completion at a next block 425. Finally processing terminates with a successful completion of the sales event at the end block 427.

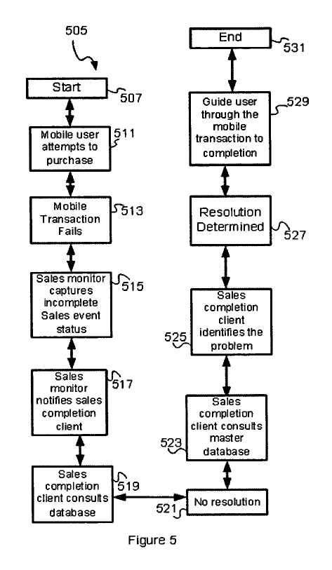

FIG. 5 is a flow chart showing an exemplary operation of the sales completion network of FIG. 1 wherein a sales completion client 109 connects to the sales management server 121 to check a master database for known issues for this mobile device and configuration, when the sales completion client 109 fails to resolve the issue accessing a local abbreviated database maintained by the sales completion client 109.

At a start block 507, the processing starts when a sales event is initiated, typically by a mobile user at a portal. At the next block 511, the mobile user attempts to purchase an application from a mobile device 107. Then, at a next block 513, the mobile transaction initiated by the mobile user fails for an unknown reason at some point in the process. Then, at a next block 515, the sales monitor 113 captures the incomplete sales event status.

Then, at a next block 517, the sales monitor 113 notifies the sales completion client 109 of incomplete sales event status. Later, at a next block 519 the sales completion client 109 compares captured event information against an abbreviated database of known issues with this mobile device 107. However, at a next block 521, the sales completion client determines that it is unable to resolve the issue using the limited amount of information in the local abbreviated database of known issues with this mobile device 107. In short, no common problem is identified.

Then, at a next block 523, the sales completion client 109 consults an external database, such as a master database associated with the sales server, to identify the problem. It identifies the problem at a next block 525. It locates a resolution, at the next block 527, and guides the user through the mobile transaction to completion at a next block 529. Finally processing terminates with a successful completion of the sales event at the end block 531.

Thus, the sales completion network 105 is capable of connecting to the sales management server to check the master database for known issues for this mobile device and configuration, in order to determine a resolution. The resolution is specific to a mobile device and sales event profile. The sales completion client uses the identified resolution and guides the user through the mobile transaction to completion

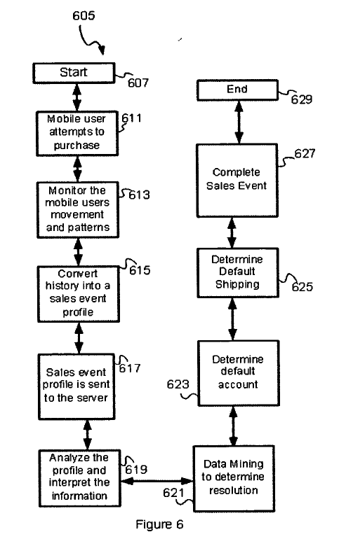

FIG. 6 is flowchart of an exemplary operation of the sales completion network 105 as it maintains and employs a data mining repository of sales events and patterns of failures. The monitoring of the mobile sales events in the mobile device and the mobile data mining to resolve interruption of sales events. At a start block 607, the processing starts when a user initiates a sales event. Then, at a next block 611, the user attempts to purchase one or more items for sale, such as one or more downloadable MP3 songs. At a next block 613, the sales monitor 113 in the device monitors the user's movement across web-pages or screens and attempts to determine patterns. In one embodiment, such monitoring is conducted by a server side sales monitor instead of by a sales monitor in the mobile device. In another related embodiment, it is conducted by a combination of a sales monitor at the carrier network 117 as well as by the sales monitor 113 on the mobile device. Thus, using the sales monitor on the device or in the carrier network (or a combination of both), the sales completion client 109 monitors the mobile users movement and patterns. Then, at a next block 615, when a failure to complete a sales event or a sales transaction is detected, the sales completion client 109 converts a sales event browsing detail, a sales selections detail, a user specified credit card information, if any, a user account information, a sales history of the user (available in the mobile device 107), etc. into a sales event profile. In one embodiment, the sales event profile is sent to the sales management system during a user activity sequence wherein the user enables a data connection, such as after a power-up of the device. The sales event browsing detail comprises information on how the user has selected one or more products for purchase, how the user has navigated the portal 337, information the user has entered when prompted by the portal or the sales management server, etc.

At a next block 617, the sales event profile is sent by the sales completion client 109 to the sales management server 121 for processing and storage. Thus, the sales completion client 109 converts user's sales history into a sales event profile and makes it available to the sales management server for sales completion activities that might be necessary. Then, at a next block 619, the sales management server 121 conducts an analysis of the sales event profile and interprets the information in the sales event profile to determine the user's intent, his selections and the user's typical modes of sales completion.

Then, at a next block 621, the sales management server 121 conducts data mining to determine a general resolution approaches for the interrupted sales event. It also determines if other users have had similar problems completing the same or similar sales events. If at least one general resolution approach is determined to exist, then the sales management server 121 initiates sales completion activities based on the determined approach. At the next block 623, a default user account that the user typically employs for conducting mobile sales events, is determined from the sales event profile or from the sales history. Then, at a next block 625, a default shipping information is determined, again, based on the sales event profile or from the sales history of the user (such as from previous sales events).

Subsequently, at the block 627, the sales management server 121 completes the sales event for the user of the mobile device 107 and communicates the result to the sales completion client 109. The sales completion client optionally displays a message to the user indicating completion of the sales event, providing the user with a prompt to retrieve it's details for perusal. In a related embodiment, the sales management server 121 also communicates an email with details of the completed sales event to the user of the mobile device employing a default email account. In a different embodiment, the sales management server 121 instructs the sales completion client 109 to complete the interrupted sales event for the user of the mobile device 107, and communicates the information needed by the sales completion client, such as those retrieved from data mining, to facilitate the completion of the sales event. In response, the sales completion client conducts the sales event from where it had been previously interrupted, without soliciting additional user inputs. It then notifies the user, employing a combination of email, SMS or other means, as appropriate.

Finally, the sales completion activities are terminated at the next end block 629. In one related embodiment, the sales management server analyzes the sales event profile and interprets the information to facilitate the completion of the user initiated sales event without any additional involvement of the user.

In one embodiment, the sales completion system for a mobile device comprises a sales completion client, a sales management server, communicatively coupled with the mobile device, that participates in a sales event and a sales monitor component that monitors the sales event. The sales monitor component detects the interruption of the sales event and communicates a sales interruption event to the sales completion client. The sales completion client facilitates the completion of the interrupted sales event. In a related embodiment of the sales completion system, the sales completion client employs a default user account and a default billing address to conduct the completion of the interrupted sales event. In another related embodiment the sales monitor component is resident in the mobile device and is capable of interacting with the sales completion client. In another related embodiment, the sales monitor component is resident in the carrier network and is communicatively coupled to the sales management server.

In a different embodiment, the sales completion system of also comprises a primary user account, a primary billing address to conduct the completion of the interrupted sales event, a secondary user account and a secondary billing address to conduct the completion of the interrupted sales event. The sales completion client selectively employs the primary user account, the secondary user account, the secondary user account and the secondary billing address to complete the interrupted sales event.

In one embodiment, the sales completion system has a sales completion client that employs a default shipping address to conduct the completion of the interrupted sales event.

In general, the sales completion system comprises a sales completion client that attempts to conduct the completion of the interrupted sales event a configurable number of times before determining to terminate the interrupted sales event without completion. In addition, the sales completion client automatically conducts the completion of the interrupted sales event. In a related yet different embodiment, the sales completion client prompts a user of the mobile device with a completion prompt to approve a sales completion activity for the interrupted sales event. The sales completion client receives approval from the user for the sales completion activity via the completion prompt and conducts the sales completion activity for the interrupted sales event.

In one embodiment of the sales completion system, the sales completion client is a downloadable software and a performance information is collected that is associated with the sales event. In a related embodiment, a sales event profile is communicated from the sales completion client to the sales management server when the sales event is interrupted. The interrupted sales event is associated with a sales promotion period. The sales completion client reminds a user of the mobile device on the imminent ending of the sales promotion period if the user had previously experienced the interrupted sales event. In addition, the sales monitor component receives a monitoring instructions associated with a termination or a continuation of the sales event at the end of the sales promotion period.

In one embodiment of the present invention, a sales completion wireless network comprises a mobile device comprising a sales completion client and a sales server, communicatively coupled with the mobile device that participates in a sales event. A sales event activity profile is communicated by the sales server to the sales completion client at the beginning of the sales event. The sales completion client detects the interruption of the sales event and uses the sales event activity profile to complete the interrupted sales event.

The sales event activity profile comprises a reference to the sales server, a session id, a reference to the user selection and a promotion id. The sales event activity profile is enhanced by the sales completion client to create a sales event profile by incorporating a client enhancement comprising a user profile comprising a user account, a user default billing address, a user default shipping address and a history of recent sales transactions. The sales completion client uses the sales event profile to complete interrupted sales event when the sales event is terminated prematurely before its completion.

The sales event activity profile comprises a sequence of ordered tasks each with a task id. The sales completion client detects an interrupted task where the sales event terminated due to an interruption among the sequence of ordered tasks. The sales completion client uses the task id, as it resumes the interrupted sales event from the interrupted task, when it attempts to complete the interrupted sales event subsequent to an interruption. In a related embodiment, the sales server tracks the sequence of ordered tasks during the sales event. The sales server determines the interrupted task among the sequence of ordered tasks where the sales event terminated due to an interruption. The sales event profile is selectively communicated to the sales server by the sales completion client when a data service communication channel is determined to be available for any purpose. In another related embodiment, the sales server resumes the sales event from the interrupted task when the sales completion client communicates its intention to resume the sales event to the sales server.

In another embodiment of the present invention, an object for sale has an wireless identification tag. The mobile device has a wireless tag component that is capable of reading the wireless identification tag off the object. The object provides its wireless identification tag to the mobile device. The sales completion client retrieves details associated with the object and displayes it to a user of the mobile device using the information retrieved from the wireless identification tag. It also solicits a user sales confirmation, and, upon receiving the user sales confirmation from the user, communicates it to the sales server. The sales server facilitates completion of the purchase of the object by the user.

In one embodiment of the present invention, a method of conducting a sales management activity for a sales event on a mobile device is facilitated. The mobile device is communicatively coupled to a sales server. The method comprises the steps of determining a sales activity profile for a sales event, monitoring sales completion, detecting sales interruption event and an interruption point, initiating sales completion from the interruption point and terminating sales completion at the end of the sales event.

The determination of the sales activity profile comprises selecting information on products, collecting a user profile and executing a sales transaction. Monitoring sales completion comprises tracking products selected during the selecting information on products, facilitating the user profile collecting employing a user profile information from a prior sales event and gathering the results of the sales transactions and a sales performance information. In one related embodiment, initiating sales completion comprises communicating, at least one of the user profile, products selected and the interruption point to the sales server. It includes resuming the sales event from the interruption point until the end of the sales event. In another related embodiment, gathering the results comprises the steps of collecting, by the sales server, from a plurality of devices, the results of the sales transactions, categorizing the results of the sales transactions, processing it for failure points and analyzing for patterns.

In another related embodiment, the method of conducting a sales management activity involves the step of initiating sales completion that comprises the step of remedying, by the sales server, at least one of the plurality of devices to facilitate sales completion and resuming the interrupted sales events on the at least one of the plurality of devices. In a related embodiment, the remedying comprises accessing, by the sales completion client in the mobile device, a problem solution information from a local problem resolution database in the mobile device. In another related embodiment, remedying comprises the step of accessing, by the sales server, a generic problem solution information from a remote problem resolution database.

In one embodiment, the method of conducting a sales management activity involves initiating sales completion, which comprises the steps of remedying access to at least one external system associated with the sales server and resuming the interrupted sales events.

In yet another embodiment of the method of conducting a sales management activity, the sales event comprises downloading of a digital information. In addition, the sales performance information comprises at least one of a download time, an installation time and a setup time collected from the mobile device.

In yet another embodiment of the present invention, a sales system for a mobile device comprises a sales management server, communicatively coupled with the mobile device that participates in a sales event. It also comprises a reference clock employed by the sales management server and a device clock in the mobile device. The sales management server sets a schedule for the sales event on the mobile device and simultaneously communicates a reference clock information to the mobile device to ensure that the device clock in the mobile device does not deviate from the reference clock.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A sales completion system for a mobile device comprising:
a sales completion client;
a sales management server, communicatively coupled with the mobile device, that participates in a sales event;
a sales monitor component that monitors the sales event;
the sales monitor component detecting the interruption of the sales event and communicating a sales interruption event to the sales completion client; and
the sales completion client facilitating the completion of the interrupted sales event.

2. The sales completion system of claim 1 wherein the sales completion client employs a default user account and a default billing address to conduct the completion of the interrupted sales event.

3. The sales completion system of claim 1 wherein the sales monitor component resident in the mobile device and capable of interacting with the sales completion client.

4. The sales completion system of claim 1 wherein the sales monitor component resident in the carrier network and communicatively coupled to the sales management server.

5. The sales completion system of claim 3 further comprising:
a primary user account;
a primary billing address to conduct the completion of the interrupted sales event;
a secondary user account;
a secondary billing address to conduct the completion of the interrupted sales event;
the sales completion client selectively employing the primary user account, the secondary user account, the secondary user account and the secondary billing address to complete the interrupted sales event.

6. The sales completion system of claim 3 wherein the sales completion client employs a default shipping address to conduct the completion of the interrupted sales event.

7. The sales completion system of claim 2 wherein the sales completion client attempts to conduct the completion of the interrupted sales event a configurable number of times before determining to terminate the interrupted sales event without completion.

8. The sales completion system of claim 7 wherein the sales completion client automatically conducts the completion of the interrupted sales event.

9. The sales completion system of claim 7 wherein the sales completion client prompts a user of the mobile device with a completion prompt to approve a sales completion activity for the interrupted sales event.

10. The sales completion system of claim 9 wherein the sales completion client receives approval from a user for the sales completion activity via the completion prompt and conducts the sales completion activity for the interrupted sales event.

11. The sales completion system of claim 1 wherein the sales completion client is a downloadable software and wherein a performance information is collected that is associated with the sales event.

12. The sales completion system of claim 1 wherein a sales event profile is communicated from the sales completion client to the sales management server when the sales event is interrupted.

13. The sales completion system of claim 1 wherein the interrupted sales event is associated with a sales promotion period and wherein the sales completion client reminds a user of the mobile device on the imminent ending of the sales promotion period if the user had previously experienced the interrupted sales event.

14. The sales completion system of claim 13 wherein the sales monitor component receives a monitoring instructions associated with a termination or a continuation of the sales event at the end of the sales promotion period.

15. A sales completion wireless network comprising:
a mobile device comprising a sales completion client;
a sales server, communicatively coupled with the mobile device, that participates in a sales event;
a sales event activity profile communicated by the sales server to the sales completion client at the beginning of the sales event;
the sales completion client detecting the interruption of the sales event and using the sales event activity profile to complete the interrupted sales event.

16. The sales completion wireless network of claim 9 wherein the sales event activity profile comprising:
a reference to the sales server;
a session id;
a reference to the user selection; and
a promotion id.

17. The sales completion wireless network of claim 16 wherein the sales event activity profile is enhanced by the sales completion client to create a sales event profile by incorporating a client enhancement comprising:
a user profile comprising a user account, a user default billing address, a user default shipping address and a history of recent sales transactions.

18. The sales completion wireless network of claim 17 wherein the sales completion client uses the sales event profile to complete interrupted sales event when the sales event is terminated prematurely before its completion.

19. The sales completion wireless network of claim 18 wherein the sales event activity profile comprises a sequence of ordered tasks each with a task id and wherein the sales completion client detects an interrupted task where the sales event terminated due to an interruption among the sequence of ordered tasks.

20. The sales completion wireless network of claim 19 wherein the sales completion client uses the task id, as it resumes the interrupted sales event from the interrupted task, when it attempts to complete the interrupted sales event subsequent to an interruption.

21. The sales completion wireless network of claim 19 wherein the sales server tracks the sequence of ordered tasks during the sales event and wherein the sales server determines the interrupted task among the sequence of ordered tasks where the sales event terminated due to an interruption and wherein the sales event profile is selectively communicated to the sales server by the sales completion client when a data service communication channel is determined to be available for any purpose.

22. The sales completion wireless network of claim 21 wherein the sales server resumes the sales event from the interrupted task when the sales completion client communicates its intention to resume the sales event to the sales server.

23. The sales completion wireless network of claim 15 further comprising:
an object with an wireless identification tag;
the mobile device having a wireless tag component that is capable of reading the wireless identification tag;
the object providing its wireless identification tag to the mobile device;
the sales completion client retrieving details associated with the object and displaying it to a user of the mobile device and soliciting a user sales confirmation; and
the sales completion client receiving the user sales confirmation from the user and communicating it to the sales server.

24. A method of conducting a sales management activity for a sales event on a mobile device, the mobile device communicatively coupled to a sales server, the method comprising:
determining a sales activity profile for a sales event;
monitoring sales completion;
detecting sales interruption event and an interruption point;
initiating sales completion from the interruption point; and
terminating sales completion at the end of the sales event.

25. The method of conducting a sales management activity according to claim 24 wherein the determining a sales activity profile comprising:
selecting information on products;
collecting a user profile; and
executing a sales transaction.

26. The method of conducting a sales management activity according to claim 24 wherein the monitoring sales completion comprising:
tracking products selected during the selecting information on products;
facilitating the user profile collecting employing a user profile information from a prior sales event; and
gathering the results of the sales transactions and a sales performance information.

27. The method of conducting a sales management activity according to claim 24 wherein initiating sales completion comprising:
communicating, at least one of the user profile, products selected and the interruption point to the sales server;
resuming the sales event from the interruption point until the end of the sales event.

28. The method of conducting a sales management activity according to claim 26 wherein gathering the results comprising:
collecting, by the sales server, from a plurality of devices, the results of the sales transactions;
categorizing the results of the sales transactions;
processing it for failure points; and
analyzing for patterns.

29. The method of conducting a sales management activity according to claim 24 wherein the initiating sales completion comprising:
remedying, by the sales server, at least one of the plurality of devices to facilitate sales completion; and
resuming the interrupted sales events on the at least one of the plurality of devices.

30. The method of conducting a sales management activity according to claim 29 wherein the remedying comprising:
accessing, by the sales completion client in the mobile device, a problem solution information from a local problem resolution database in the mobile device.

31. The method of conducting a sales management activity according to claim wherein the remedying further comprising:
accessing, by the sales server, a generic problem solution information from a remote problem resolution database.

32. The method of conducting a sales management activity according to claim 24 wherein the initiating sales completion comprising:
remedying access to at least one external system associated with the sales server; and
resuming the interrupted sales events.

33. The method of conducting a sales management activity according to claim 26 wherein the sales event comprises the download of a digital information and wherein the sales performance information comprises at least one of a download time, an installation time and a setup time collected from the mobile device.

34. A sales system for a mobile device comprising:
a sales management server, communicatively coupled with the mobile device, that participates in a sales event;
a reference clock employed by the sales management server;
a device clock in the mobile device;
the sales management server setting a schedule for the sales event on the mobile device and simultaneously communicating a reference clock information to the mobile device to ensure that the device clock in the mobile device does not deviate from the reference clock.

35. A sales system for a mobile device comprising:
a sales management server, communicatively coupled with the mobile device, that participates in a sales event;
an item for purchase with an associated wireless identification tag;
the wireless identification tag capable of communicating with the mobile device;
the mobile device gathering an item profile for the item via the wireless identification tag; and
the mobile device gathering the item profile and communicating it to the sales management server for determination of details of the item such as its price and availability.
